(19) United States
(12) Patent Application Publication
(10) Pub. No.: US 2016/0220336 A1
(43) Pub. Date: Aug. 4, 2016

(54) ARTICULATOR

(71) Applicants: Tae-Hee BYUN, Busan (KR); GEOSEUNG CO., LTD., Gyeongsangnam-do (KR)

(72) Inventors: Tae-Hee Byun, Busan (KR); Min-Sung Park, Busan (KR); Byung-Moon Kim, Gyeongsangnam-do (KR); Jae-Hyung Byun, Busan (KR)

(21) Appl. No.: 15/022,499

(22) PCT Filed: Sep. 5, 2014
(86) PCT No.: PCT/KR2014/008374

§ 371 Date: Mar. 16, 2016

(30) Foreign Application Priority Data
Sep. 17, 2013 (KR) 10-2013-0112011

(51) Int. Cl. A61C 11/00; A61C 11/06; A61C 11/08

(52) U.S. Cl. CPC A61C 11/006; A61C 11/085; A61C 11/06

(57) ABSTRACT

An articulator including: a lower member in which an attachment plate and a body can be firmly and easily attached and detached by fitting a rear coupling part to a housing part without using a plaster, the attachment plate can be easily separated by first fixing pins protruding downward from the body, and the attachment plate and an oral model can be accurately cut by cutting marks, tooth center marks, and a round groove on the attachment plate and tooth center marks on the body; and an upper member where an impression of counter-teeth corresponding to the oral model attached to the lower member, in which the lower and upper members are rotatably connected by connecting mechanisms. Accordingly, the manufacturing process can be simplified, the actual motion of jawbones can be achieved, and the height between the upper member and the lower member can be ensured by a support unit.

### TECHNICAL FIELD

The present invention relates to an articulator and, more particularly, to an articulator including: a lower member in which an attachment plate and a body can be firmly and easily attached and detached by fitting a rear coupling part to a housing part without using a plaster, the attachment plate can be easily separated by first fixing pins protruding downward from the body, and the attachment plate and an oral model can be accurately cut by cutting marks, tooth center marks, and a round groove on the attachment plate and tooth center marks on the body; and an upper member where an impression of counter-teeth corresponding to the oral model attached to the lower member, in which the lower member and the upper member are rotatably connected by connecting mechanisms; and accordingly, the manufacturing process can be simplified, the actual motion of jawbones can be achieved, and the height between the upper member and the lower member can be ensured by a support unit.

### BACKGROUND ART

Teeth are generally formed in an elliptical arc shape to chew food by meeting each other by an up-down motion of jawbones, but when the teeth are damaged, accurate occlusion is difficult and malfunction of the teeth is caused. When a tooth is damaged, a prosthesis is implanted at the position where the tooth has been, to replace it. In order to accurately manufacture and implant the prosthesis, auxiliary devices such as an oral model, a model assembly, and an articulator are used. That is, an oral model manufactured on the basis of the states of a tooth and a gum of a patient is attached to a model assembly and the model assembly is mounted on an articulator to set the accurate shape (size) and position of an artificial tooth to be manufactured. The oral model is manufactured using an auxiliary device such as a model assembly that can be easily separated and attached/detached.

The model assembly is generally composed of an attachment plate where an oral model is attached and a body where the attachment plate is combined. The attachment plate can be cut for the position of a tooth to be replaced, that is, for each tooth, with the oral model attached.

However, in the model assembly of the related art, a plaster is used for combining the attachment plate and the body, so using the plaster takes time and dust and sludge are produced. After the attachment plate with an oral model is cut, shaking may occur, and particularly, it is required to hit a pin of the attachment plate on the bottom of the body in order to separate the cut attachment plate from the body, so it is inconvenient. Further, when separate teeth are loose, an accurate contact surface cannot be formed between the teeth.

Further, a worker determines a cutting point (division point) on the basis of his/her experience when cutting and separating an attachment plate where an oral model is attached, in the model assemblies of the related art, an error can be easily generated, and particularly, the fixing pins on the bottom of the attachment plate are damaged or cut in the process of cutting.

Further, counter-teeth of an oral model for teeth to be replace (manufactured) are hardened by pouring a plaster to an impression taking the state of a mouth, and then separated and attached to an articulator in the related art, so the work process is complicated and the manufacturing time is long due to use of a plaster. The following Patent Document also proposes an articulator where an oral model for counter-teeth can be easily attached and detached, but it still has the problem of a complicated process of manufacturing a model using a plaster.

### Patent Document

Korean Patent No. 10-0944812, titled “Combinatorial structure of tooth model with coupling module”.

### DISCLOSURE

### Technical Problem

The present invention has been made in an effort to solve the problems and an object of the present invention is to provide an articulator that includes a lower member where an oral model for teeth to be manufactured is seated, an upper member where an impression of counter-teeth is seated, and connecting mechanisms rotatably connecting the lower member and the upper member to each other, in which the lower member includes: an attachment plate having a model seat on a top where the oral model is fixed and a rear coupling part protruding downward to be detachably coupled to a body; and the body having a housing part for coupling the rear coupling part to the attachment plate by pressing the rear coupling part so that the attachment plate is fixed to the body without using a plaster; and accordingly, the attachment plate can be firmly and easily attached and detached, and a model can be directly formed by attaching an impression of teeth corresponding to teeth to be manufactured, thereby simplifying the process of manufacturing a prosthesis.

Another object of the present invention is to provide an articulator including an upper member that has a counter-tooth seat where the impression of counter-teeth corresponding to the oral model is seated, in which the counter-tooth seat is formed in a curved plate shape higher at front and rear sides and has a space for keeping an adhesive so that the impression is easily seated and fixed and an excessive adhesive is easily removed.

Another object of the present invention is to provide an articulator including a rear coupling part that has first fixing pins fitted downward through the body and a housing part that has first coupling holes where the first fixing pins are fixed to hold the attachment plate so that the attachment plate can be easily separated using the protruding first fixing pins.

Another object of the present invention is to provide an articulator in which first coupling holes have a holding portion protruding inward and the cylindrical first fixing pins are inserted in the holding portions further protruding at the lower portions so that the first fixing pins inserted through the first coupling holes can be more strongly fixed and movement of the first fixing pins is prevented after cutting.

Another object of the present invention is to provide an articulator includes a rear coupling part that has second fixing pins formed at both sides of the first fixing pins and inserted in the body and a housing part that has second coupling holes where the second fixing pins are inserted to prevent rotation, easily set a position of the attachment plate combined with the body, and more strongly attach the attachment plate to the body.

Another object of the present invention is to provide an articulator includes a rear coupling part that has rear projections that are inserted in the body and under which the first and second fixing pins are formed and a housing part that has rear projection grooves where the rear projections are inserted and under which the first and second coupling holes are formed, in which the rear projections and the rear projection grooves are tapered such that cross-sections of lower portions become small so that the rear projections are easily inserted and the attachment plate is more stably fixed to the attachment plate.

Another object of the present invention is to provide an articulator that has cutting marks indicating portions between teeth on the model seat and positioned between adjacent first fixing pins so that the oral model and the attachment plate are accurately cut by the cutting marks.

Another object of the present invention is to provide an articulator that includes tooth center marks indicating centers of teeth on the model seat and a counter-tooth seat so that the oral model or the impression of counter-teeth can be easily attached to an accurate position.

Another object of the present invention is to provide an articulator that has a round groove formed along an edge of the model seat of the attachment plate to prevent an adhesive from overflowing the attachment plate and the body when the oral model is attached.

Another object of the present invention is to provide an articulator in which when the attachment plate is combined with the body, an outer side of the attachment plate protrudes further than an outer side of the body so the attachment plate can be easily separated by the protruding portion.

Another object of the present invention is to provide an articulator that includes: arms formed at both sides of an end of each of the lower member and the upper member; balls formed at an end of one of the arms; and a pocket formed at an end of the other arm and having an open top, in which the ball formed at the arm of the lower member is inserted in the pocket formed at the arm of the upper member and the ball formed at the arm of the upper member is inserted in the pocket formed at the arm of the lower member so that the upper member and the lower member can be freely combined and separated and the upper member and the lower member can be easily moved up and down and left and right to achieve the actual motion of jawbones.

Another object of the present invention is to provide an articulator that includes a pocket that has a spherical shape with an open top and is cut at a position higher than a center of the sphere to prevent the ball from being separated from the pocket, so that the articulator can be stably fixed even by free rotation of the upper body and the lower body and the oral model attached by an adhesive can be prevented from being damaged due to separation of the upper member and the lower member.

Another object of the present invention is to provide an articulator that includes a pocket having a slot at the rear side so that a ball can be easily inserted into the pocket and the lower member and the upper member are rotated at 180°, thereby easily attaching/detaching the oral model, the attachment plate, and the impression.

Another object of the present invention is to provide an articulator that includes a pocket that has a stopper formed at the top of a front side to support the arm so that a minimum height is ensured between the upper member and the lower member, damage to the oral model due the hitting is prevented, and stable work can be performed by preventing the arm from moving down under a predetermined height.

Another object of the present invention is to provide an articulator that includes a support unit including a pin having a first end coupled and fixed to the lower member and a second end supported on the upper member to ensure the minimum height between the upper member and the lower member.

Another object of the present invention is to provide an articulator that includes a pin hole formed at the lower member and having a thread on an inner side and a pin having a thread on an outer side of an end and being thread-fastened to the pin hole so that the height between the upper member and the lower member can be adjusted, thereby ensuring a larger height when a back tooth close to the pin is manufactured.

Another object of the present invention is to provide an articulator that includes a support hole formed at the upper member and supporting the second end of the pin and a pin formed in a spherical shape having a diameter lager than the support hole so that the upper member rotate on the second end of the pin, thereby allowing the upper member and the lower member to replicate the natural motion of jawbones.

Another object of the present invention is to provide an articulator that includes a guide surface formed at the upper member and guiding the second end of the pin and a pin having a second end formed in a spherical shape, in which the guide surface is curved to be complementary to the second end of the pin so that the upper member rotates with the guide surface and the second end of the pin in contact with each other, so the upper member and the lower member replicate the natural motion of jawbones.

Another object of the present invention is to provide an articulator that includes an upper member and a lower member that are one-side parts where an oral model and an impression for only some of teeth are attached respectively so that a prosthesis can be manufactured by taking the shape of only some of teeth.

Another object of the present invention is to provide an articulator that includes an upper member and a lower member that are whole-teeth parts where an oral model and an impression for all teeth are attached respectively so that a prosthesis can be manufactured by taking the shape of all teeth.

### Technical Solution

An articulator for achieving the objects of the present invention includes the following configurations.

An articulator according to an embodiment of the present invention includes a lower member where an oral model for teeth to be manufactured is seated, an upper member where an impression for counter-teeth is seated, and connecting mechanisms rotatably connecting the lower member and the upper member to each other, in which the lower member includes: an attachment plate having a model seat on a top where the oral model is fixed and a rear coupling part protruding downward to be detachably coupled to a body; and the body having a housing part for coupling the rear coupling part to the attachment plate by pressing the rear coupling part.

According to another embodiment of the present invention, in the articulator, the upper member has a counter-tooth seat where the impression of counter-teeth corresponding to the oral model is seated and the counter-tooth seat is formed in a curved plate shape higher at front and rear sides and has a space for keeping an adhesive so that the impression is easily seated and fixed.

According to another embodiment of the present invention, in the articulator, the rear coupling part has first fixing pins fitted downward through the body and the housing part has first coupling holes where the first fixing pins are fixed so that the attachment plate is easily separated.

According to another embodiment of the present invention, in the articulator, the first coupling holes have a holding portion protruding inward to hold the first fixing pins inserted through the first coupling holes.

According to another embodiment of the present invention, in the articulator, the holding portion is divided into a plurality of parts so that the first fixing pin is easily inserted and firmly fixed.

According to another embodiment of the present invention, in the articulator, the first fixing pin is formed in a cylindrical rod shape and the holding portion is tapered to further protrude at a lower portion.

According to another embodiment of the present invention, in the articulator, the rear coupling part has second fixing pins formed at both sides of the first fixing pins and inserted in the body and the housing part has second coupling holes where the second fixing pins are inserted to prevent rotation and easily set a position of the attachment plate combined with the body.

According to another embodiment of the present invention, in the articulator, the rear coupling part has rear projections that are inserted in the body and under which the first and second fixing pins are formed and the housing part has rear projection grooves where the rear projections are inserted and under which the first and second coupling holes are formed so that the attachment plate is more stably fixed to the body.

According to another embodiment of the present invention, in the articulator, the rear projections and the rear projection grooves are tapered such that cross-sections of lower portions become small.

According to another embodiment of the present invention, in the articulator, the attachment plate has cutting marks indicating portions between teeth on the model seat and positioned between adjacent first fixing pins so that the oral model and the attachment plate are accurately cut by the cutting marks.

According to another embodiment of the present invention, in the articulator, the cutting marks are formed at both sides of the model seat so that the attachment plate is accurately cut along a line connecting the cutting marks at both sides, even with the oral model in the model seat.

According to another embodiment of the present invention, in the articulator, the attachment plate has a round groove formed along an edge of the model seat to prevent overflow of an adhesive for fixing the oral model to the model seat.

According to another embodiment of the present invention, in the articulator, when the attachment plate is combined with the body, an outer side of the attachment plate protrudes further than an outer side of the body.

According to another embodiment of the present invention, in the articulator, tooth center marks indicate centers of teeth on the model seat and a counter-tooth seat.

According to another embodiment of the present invention, in the articulator, the tooth center marks are engraved or embossed at both sides of the attachment plate, the body, and the upper member.

According to another embodiment of the present invention, in the articulator, the tooth center marks are identification numbers written at centers of teeth on the model seat and the counter-tooth seat.

According to another embodiment of the present invention, in the articulator, the connecting mechanism includes: arms formed at both sides of an end of each of the lower member and the upper member; balls formed at an end of one of the arms; and a pocket formed at an end of the other arm and having an open top, wherein the ball formed at the arm of the lower member is inserted in the pocket formed at the arm of the upper member and the ball formed at the arm of the upper member is inserted in the pocket formed at the arm of the lower member.

According to another embodiment of the present invention, in the articulator, the pocket has a spherical shape with an open top and is cut at a position higher than a center of the sphere to prevent the ball from being separated from the pocket.

According to another embodiment of the present invention, in the articulator, a slot is formed at a rear side of the pocket so that the lower member and the upper member are rotated at 180°.

According to another embodiment of the present invention, in the articulator, the pocket has a stopper formed at the top of a front side to support the arm so that a minimum height is ensured between the upper member and the lower member.

The articulator according to another embodiment of the present invention includes a support unit for ensuring a height between the upper member and the lower member and includes a pin having a first end coupled and fixed to the lower member and a second end supported on the upper member.

According to another embodiment of the present invention, in the articulator, the support unit includes a pin hole formed at the lower member and having a thread on an inner side and the first end of the pin has a thread on an outer side and is thread-fastened to the pin hole, so the height between the upper member and the lower member can be adjusted.

According to another embodiment of the present invention, in the articulator, the support unit includes a support hole formed at the upper member and supports the second end of the pin, and the second end of the pin is formed in a spherical shape having a diameter lager than the support hole so that the upper member rotates on the second end of the pin, so the upper member and the lower member can replicate the natural motion of jawbones.

According to another embodiment of the present invention, in the articulator, the support unit includes a guide surface formed at the upper member and guiding the second end of the pin, the second end of the pin is formed in a spherical shape, and the guide surface is curved to be complementary to the second end of the pin so that the upper member rotates with the guide surface and the second end of the pin in contact with each other, so the upper member and the lower member can replicate the natural motion of jawbones.

According to another embodiment of the present invention, in the articulator, the upper member and the lower member are one-side parts where an oral model and an impression for only some of teeth are attached respectively, or an oral model and an impression for whole teeth are attached to the upper member and the lower member.

### Advantageous Effects

The present invention can obtain the following effects from the embodiments, and the configurations and combination and use relationships to be described below.

The present invention includes a lower member where an oral model for teeth to be manufactured is seated, an upper member where an impression of counter-teeth is seated, and connecting mechanisms rotatably connecting the lower member and the upper member to each other, in which the lower member includes: an attachment plate having a model seat on a top where the oral model is fixed and a rear coupling part protruding downward to be detachably coupled to a body; and the body having a housing part for coupling the rear coupling part to the attachment plate by pressing the rear coupling part so that the attachment plate is fixed to the body without using a plaster. Accordingly, the attachment plate can be firmly and easily attached and detached, and a model can be directly formed by attaching an impression of teeth corresponding to teeth to be manufactured, thereby simplifying the process of manufacturing a prosthesis.

The present invention includes an upper member that has a counter-tooth seat where the impression of counter-teeth corresponding to the oral model is seated, in which the counter-tooth seat is formed in a curved plate shape higher at front and rear sides and has a space for keeping an adhesive, so the impression can be easily seated and fixed and excessive adhesive can be easily removed.

The present invention includes a rear coupling part that has first fixing pins fitted downward through the body and a housing part that has first coupling holes where the first fixing pins are fixed to hold the attachment plate, so the attachment plate can be easily separated using the protruding first fixing pins.

The present invention includes first coupling holes having a holding portion protruding inward and the cylindrical first fixing pins are inserted in the holding portions further protruding at the lower portions, so the first fixing pins inserted through the first coupling holes can be more strongly fixed and movement of the first fixing pins can be prevented after cutting.

The present invention includes a rear coupling part that has second fixing pins formed at both sides of the first fixing pins and inserted in the body and a housing part that has second coupling holes where the second fixing pins are inserted, so it is possible to prevent rotation, easily set a position of the attachment plate combined with the body, and more strongly attach the attachment plate to the body.

The present invention includes a rear coupling part that has rear projections that are inserted in the body and under which the first and second fixing pins are formed and a housing part that has rear projection grooves where the rear projections are inserted and under which the first and second coupling holes are formed, in which the rear projections and the rear projection grooves are tapered such that cross-sections of lower portions become small, so the rear projections can be easily inserted and the attachment plate can be more stably fixed to the attachment plate.

The present invention has cutting marks indicating portions between teeth on the model seat and positioned between adjacent first fixing pins, so the oral model and the attachment plate can be accurately cut by the cutting marks.

The present invention includes tooth center marks indicating centers of teeth on the model seat and a counter-tooth seat, so the oral model or the impression of counter-teeth can be easily attached to an accurate position.

The present invention has a round groove formed along an edge of the model seat of the attachment plate, so it is possible to prevent an adhesive from overflowing the attachment plate and the body when the oral model is attached.

According to the present invention, when the attachment plate is combined with the body, an outer side of the attachment plate protrudes further than an outer side of the body, so the attachment plate can be easily separated by the protruding portion.

The present invention includes: arms formed at both sides of an end of each of the lower member and the upper member; balls formed at an end of one of the arms; and a pocket formed at an end of the other arm and having an open top, in which the ball formed at the arm of the lower member is inserted in the pocket formed at the arm of the upper member and the ball formed at the arm of the upper member is inserted in the pocket formed at the arm of the lower member, so the upper member and the lower member can be freely combined and separated and the upper member and the lower member can be easily moved up and down and left and right to replicate the actual motion of jawbones.

The present invention includes a pocket that has a spherical shape with an open top and is cut at a position higher than a center of the sphere to prevent the ball from being separated from the pocket, so the articulator can be stably fixed even by free rotation of the upper body and the lower body and the oral model attached by an adhesive can be prevented from being damaged due to separation of the upper member and the lower member.

The present invention includes a pocket having a slot at the rear side, so a ball can be easily inserted into the pocket and the lower member and the upper member are rotated at 180°, thereby easily attaching/detaching the oral model, the attachment plate, and the impression.

The present invention includes a pocket that has a stopper formed at the top of a front side to support the arm, so a minimum height is ensured between the upper member and the lower member, damage to the oral model due to hitting is prevented, and stable work can be performed by preventing the arm from moving down under a predetermined height.

The present invention includes a support unit including a pin having a first end coupled and fixed to the lower member and a second end supported on the upper member, so a minimum height can be ensured between the upper member and the lower member.

The present invention includes a pin hole formed at the lower member and having a thread on an inner side and a pin having a thread on an outer side and being thread-fastened to the pin hole, so the height between the upper member and the lower member can be adjusted, thereby ensuring a larger height when a back tooth close to the pin is manufactured.

The present invention includes a support hole formed at the upper member and supporting the second end of the pin and a pin formed in a spherical shape having a diameter lager than the support hole so that the upper member rotates on the second end of the pin, thereby allowing the upper member and the lower member to replicate the natural motion of jawbones.

The present invention includes a guide surface formed at the upper member and guiding the second end of the pin and a pin having a second end formed in a spherical shape, in which the guide surface is curved to be complementary to the second end of the pin so that the upper member rotates with the guide surface and the second end of the pin in contact with each other, so the upper member and the lower member can replicate the natural motion of jawbones.

The present invention includes an upper member and a lower member that are one-side parts where an oral model and an impression for only some of teeth are attached respectively, so a prosthesis can be manufactured by taking the shape of only some of teeth.

The present invention includes an upper member and a lower member that are whole-teeth parts where an oral model and an impression for all teeth are attached respectively, so a prosthesis can be manufactured by taking the shape of all teeth.

### DESCRIPTION OF DRAWINGS

FIG. 1 is a perspective view of an articulator according to an embodiment of the present invention.

FIG. 2 is an exploded perspective view of the articulator according to an embodiment of the present invention.

FIG. 3 is a cross-sectional view showing use of the articulator according to an embodiment of the present invention.

FIG. 4 is an exploded perspective view of a lower member of the articulator according to an embodiment of the present invention.

FIG. 5 is a perspective view of an attachment plate of FIG. 4.

FIG. 6 is a perspective view of a body of FIG. 4.

FIG. 7 is a cross-sectional view taken along line A-A of FIG. 6.

FIG. 8 is a perspective view of an assembly of the attachment plate and the body of FIG. 4.

FIG. 9 is a cross-sectional view taken along line B-B of FIG. 8.

FIG. 10 is a perspective view and a plan view an oral model combined with the attachment plate.

FIG. 11 is a view showing a portion cut off the oral model and the attachment plate and separated from the body.

FIG. 12 is a perspective view of an upper body of FIG. 1.

FIG. 13 is a view showing operation of a connecting mechanism of FIG. 1.

FIG. 14 is a perspective view of an articulator according to another embodiment of the connecting mechanism of FIG. 1.

FIG. 15 is a view showing a coupling state of a support member of FIG. 1.

FIG. 16 is a view showing a coupling state according to another embodiment of the support member of FIG. 1.

FIG. 17 is a perspective view of an articulator according to another embodiment of the present invention.

FIG. 18 is an exploded perspective view of FIG. 17.

### MODE FOR INVENTION

Hereinafter, exemplary embodiments of an articulator according to the present invention will be described with reference to the accompanying drawings. Further, in describing the present invention, detailed descriptions of well-known functions or configurations relating to the present invention will not be provided so as not to obscure the description of the present invention with unnecessary details. Further, unless explicitly described otherwise, “comprising” any components will be understood to imply the inclusion of other components rather than the exclusion of any other components.

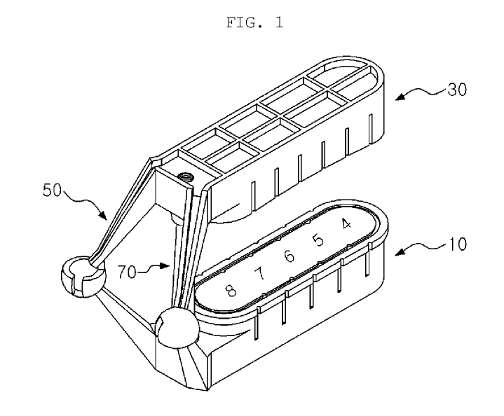

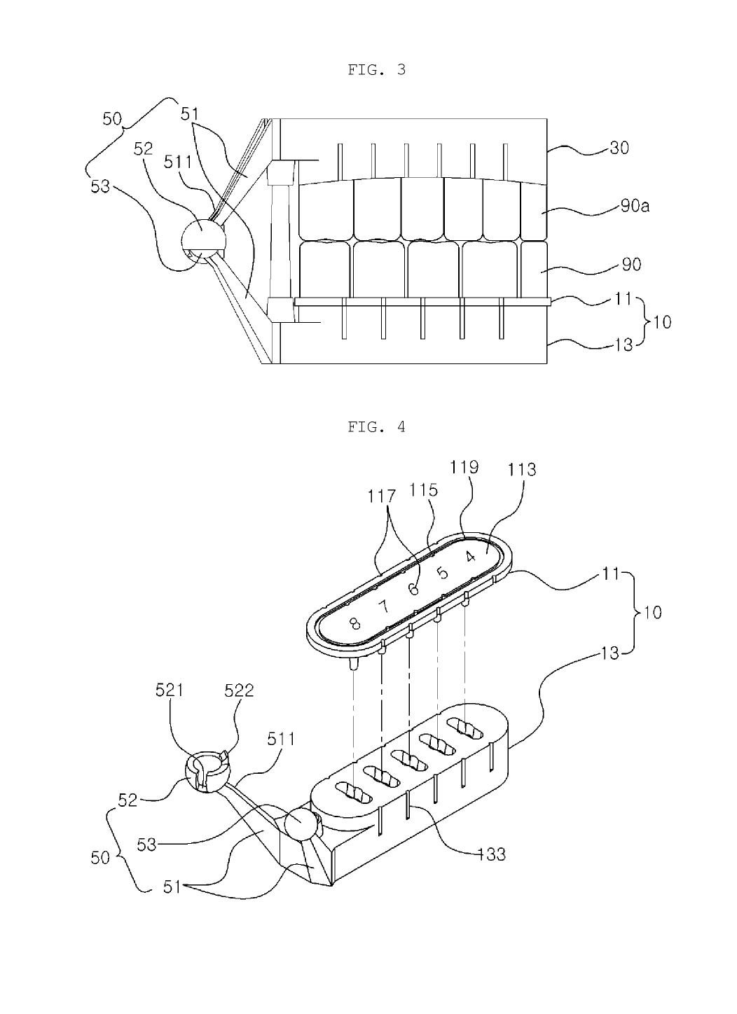

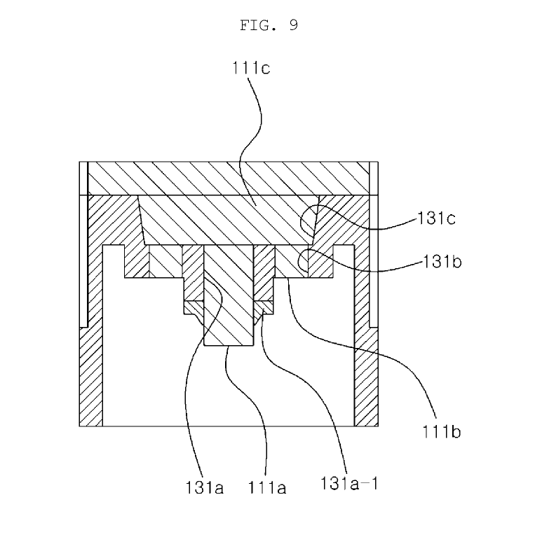

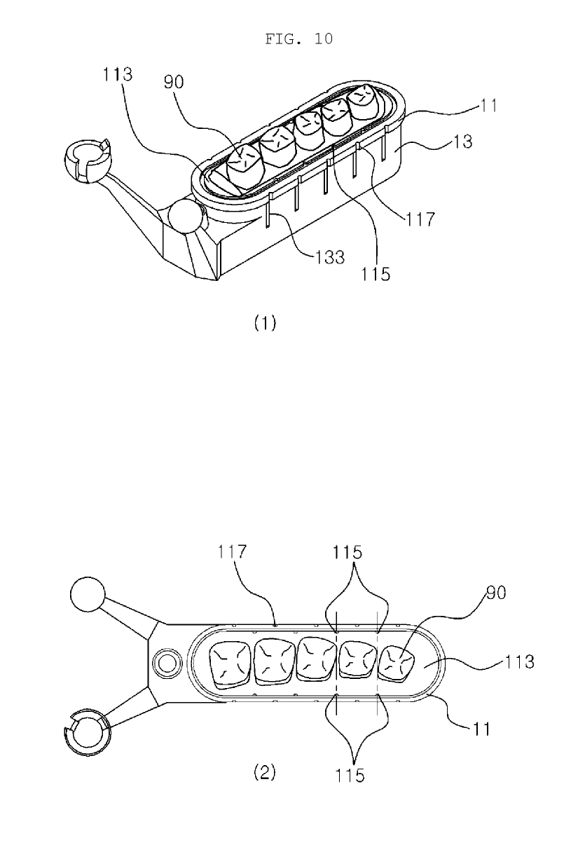

Referring to FIGS. 1 to 16 to describe an articulator according to an embodiment of the present invention, the articulator includes a lower member 10 where an oral model for teeth to be manufactured is placed, an upper member 30 where an impression of counter-teeth is placed, and a connecting mechanism 50 rotatably connecting the lower member 10 and the upper member 30, in which the lower member 10 includes an attachment plate 11 having a model seat 113 on the top where the oral model 90 is fixed and a rear coupling part 111 protruding downward to be detachably coupled to a body, and the body having a housing part 131 for coupling the rear coupling part 111 to the attachment plate 11 by pressing it.

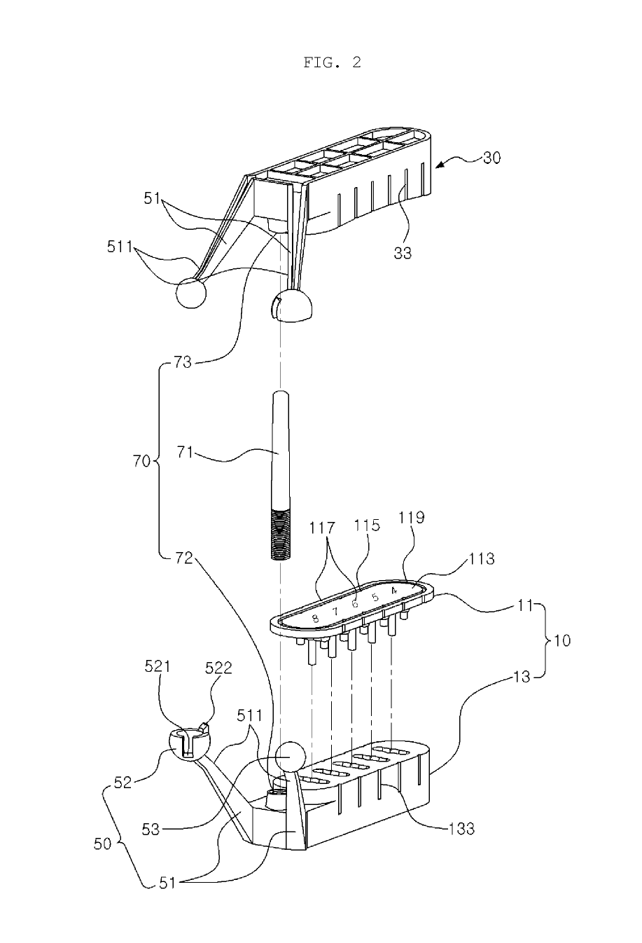

The lower member 10 includes the attachment plate 11 where the oral model 90 is placed and the body 13 is combined with the attachment plate 11. The lower body 10 is integrally formed with the connecting mechanism 50 and forms a side of the articulator and the oral model 90 of teeth to be manufactured is attached to the lower member to meet an oral model 90a of counter-teeth of the impression attached to the upper member 30, thereby setting accurate position and shape. Accordingly, there is no need for a process of attaching a model assembly to an articulator again, as in the related art, so the work can be simplified, and it is possible to stably work with the articulator, as compared with a model assembly of the related art that requires two bonding processes using an adhesive. Further, the lower member 10 has a pin hole 72 that is formed at the side connected with the connecting mechanism 50 so that a pin 71 to be described below can be inserted therein, as shown in FIG. 2, and a thread is formed on the inner side of the pin hole 72. Obviously, configurations other than the thread may be used as long as the pin 71 can be fixed. The pin 71 and the pin hole 72 will be described in detail below.

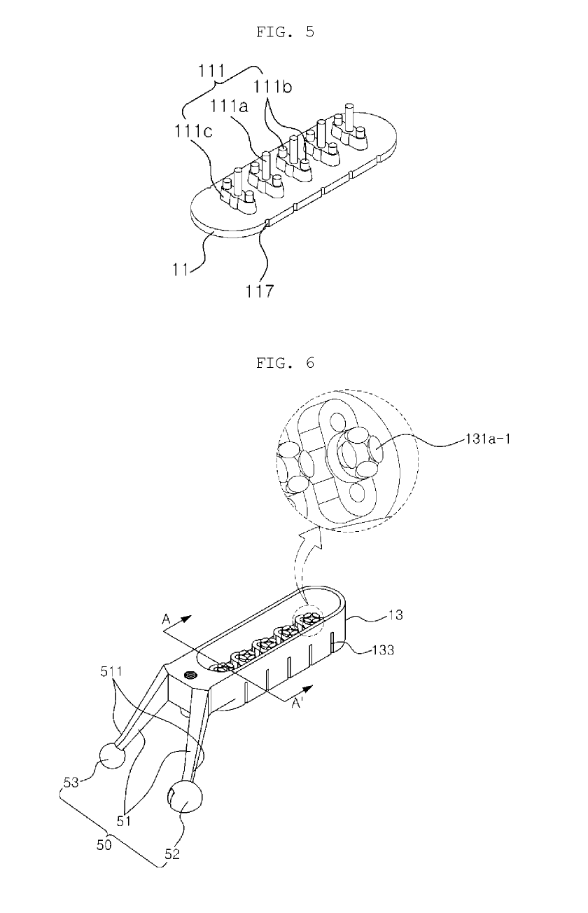

Referring to FIGS. 4 to 11, the attachment plate 11, which is the upper part of the lower member 10, is the part where the oral model 90 taking the current shape inside the mouth of a patient who wants a prosthesis and diagnosis and which is cut with the oral model 90 when the oral model 90 is cut. That is, in the process of diagnosing a patient and manufacturing a prosthesis, an oral model for the current states of the teeth and gums of the patient is manufactured and is then attached to the attachment plate 11 and the attachment plate 11 is combined with the body 12 to meet the oral model of counter-teeth, thereby setting the accurate shapes and positions of artificial teeth to be manufactured. Thereafter, the oral model can be cut to be used for the positions. Further, the attachment plate 11 may be formed larger than the body 13 that is coupled to the bottom of the attachment plate such that the edge of the attachment plate 11 protrudes further than the edge of the body 13 when they are combined so that a worker can easily hold and separate the attachment plate 11. Further, the attachment plate 11 may be formed as a one-side part where an oral model taking only some of teeth so that a prosthesis can be simply manufactured using the oral model only for the teeth to be replaced (manufactured). Obviously, as shown in FIG. 17, an oral model taking the shapes of whole teeth may be attached to manufacture a prosthesis. The attachment plate 11, as shown in FIG. 5, has the rear coupling part 111 so that the attachment plate 11 and the body 13 can be firmly combined and the attachment plate 11 can be easily detached and the rear coupling part 111 may have first and second fixing pins 111a and 111b and rear projections 111c.

The first fixing pins 111a extend a predetermined length downward from the attachment plate 11, are arranged with intervals corresponding to them of natural teeth, and are inserted through first coupling holes 131a of the body 13. Accordingly, the first fixing pins 111a inserted downward through the body 13 allow a worker to easily separate the attachment plate 11 from the body 13 later by using (holding or hitting) their ends. The first fixing pins 111a protrude from the rear projections 111c, when the rear coupling part 111 has the rear projections 111c. Further, the first fixing pins 111a are preferably formed in the shape of a cylindrical rod, as shown in FIG. 5, but may be formed in various shapes in accordance with the shapes of holding portions 131a formed at the first coupling holes 131a to be described below, and they may be tapered such that the cross-sections of the lower portions become small to be more strongly fixed by the holding portions 131a.

The second fixing pins 111b are inserted in second coupling holes 131b of the body 13 and are formed at both sides of the first fixing pins 111a so that the attachment plate 11 cannot turn without shaking and the attachment plate 11 can be combined with the body 13 at the accurate positions. Further, the second fixing pins 111b are forcibly fitted in the second coupling holes 131b, so the attachment plate 11 can be more strongly fixed to the body 13. Further, the second fixing pins 111b can be formed in various shapes as long as they can be forcibly fitted into the second coupling holes 131b. The second fixing pins 111b are also formed on the rear projections 111c, when the rear coupling part 111 has the rear projections 111c. Further, the second fixing pins 111b do not protrude downward from the body 13 to prevent inconvenience or damage to the first and second fixing pins when the attachment plate 11 is separated later.

The rear projections 111c are formed on the bottom of the attachment plate 11 and inserted in rear projection grooves 131c formed on the body 13 and the first and second fixing pins 111a and 111b are formed on the bottom of the rear projections. The rear projections 111c may also be formed in various shapes, but are preferably tapered such that the cross-sections of the lower portions become smaller so that they can be easily inserted into the rear projection grooves 131c. As the rear projections 111c are inserted in the rear projection grooves 131c, the outer sides of the rear projections 111c and the inner sides of the rear projection grooves 131c are in close contact with each other, so the attachment plate 11 can be more firmly coupled to the body 13.

The model seat 113, as shown in FIG. 4, is the top of the attachment plate 11 and the oral model 90 for teeth to be replaced (manufactured) is attached to the model seat 113 by an adhesive substance such as a plaster. Cutting marks 115 and tooth center marks 117 are formed on the model seat 113 and a round groove 119 is formed around the edge of the model seat 113. The oral model 90 is attached to the model seat 113 at the accurate position 113 by the tooth center marks 117.

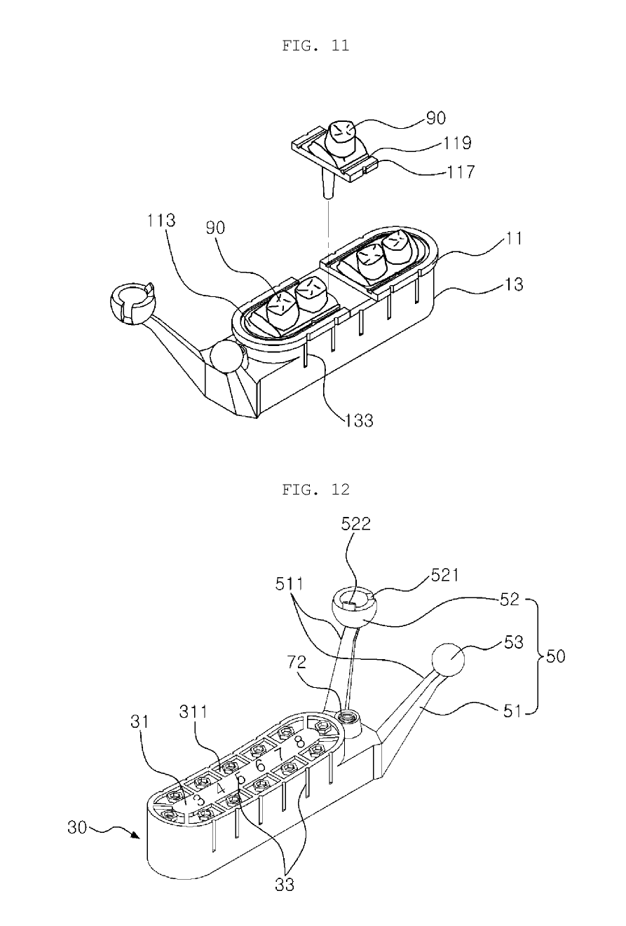

The cutting marks 115, as shown in FIG. 4, indicate the portions between teeth on the model seat 113, are positioned between a first fixing pin 111a and an adjacent fixing pin 111a, and are drawn or engraved along the edge of the model seat 113 so that the oral model 90 and the attachment plate 11 can be accurately cut by the cutting marks 115. As stated as a problem in the related art above, since a worker determines a cutting point (division pint) on the basis of his/her experience when cutting and separating an attachment plate where an oral model is attached, in the model assemblies of the related art, an error can be easily generated, and particularly, the fixing pins on the bottom of the attachment plate are damaged or cut in the process of cutting. Accordingly, the cutting marks 115 showing the cutting positions are provided between adjacent first fixing pins 111a on the model seat 113 to solve errors that may be generated in the process of cutting the oral model 90 and the attachment plate 11 in the present invention. Further, the cutting marks 115, as shown in FIG. 12, are provided at both sides of the model seat 113 so that the attachment plate can be accurately cut along the line connecting the cutting marks 115 at both sides, even with the oral model 90 on the model seat 113. Accordingly, as shown in FIG. 11, it is possible to prevent the first and second fixing pins 111a and 111b from being damaged or cut in the process of cutting and to manufacture a prosthesis having an accurate shape.

The tooth center marks 117 indicate the centers of teeth that are arranged on the model seat 113, and, as shown in FIG. 4, identification numbers may be written at the centers of teeth on the model seat 113 or the tooth center marks may be embossed or engraved at both sides of the attachment plate 11. Accordingly, it is possible to check the center positions of teeth on the oral model 90 when attaching the oral model 90 to the model seat 113 of the attachment plate 11, so it is possible to accurately and easily determine the position of the oral model 90.

The round groove 119 is formed along the edge of the model seat 113, as shown in FIG. 4, to prevent overflow of an adhesive for fixing the oral model 90 to the model seat 113. Since the round groove 119 is formed along the edge of the model seat 113 where the oral model 90 is fixed on the attachment plate 11, the bottom of the oral model 90 and the adhesive on the model seat 113 are kept inside the around groove 110 and the adhesive cannot overflow the sides of the attachment plate 11 to the body 13 after being bonded to the model seat 113. Accordingly, it is possible to particularly prevent interference with separation of the attachment plate 11 due to bonding of the attachment plate 11 to the body 13 by the adhesive.

Referring to FIGS. 4, and 6 to 9, the body 13 is the lower part of the lower member 10 on which the attachment plate 11 is mounted and is integrated with the connecting mechanism 50 with the attachment plate 11 combined with the oral model 90 thereon, so there is no need for the process of attach a model assembly to an articulator in the related art and it is possible to check the shape, position, and occlusion state of a prosthesis to be manufactured. The body 13 includes the housing part 131 where the rear coupling part 111 of the attachment plate 11 is coupled, in order to firmly couple the attachment plate 11 to the body 13 and easily separate the attachment plate 11. The housing part 131 may have first and second coupling holes 131a and 131b and rear projection grooves 131c where the first and second pins 111a and 111b and the rear projections 111c are inserted and fixed. Further, the first coupling holes 131a may have a holding portion 131a-1 so that the first fixing pins 111a can be further strongly fixed.

The first fixing pins 111a are inserted in the first coupling holes 131a and the first coupling holes 131a may protrude downward at a predetermined distance and may be formed under the rear projection grooves 131c when the rear projection grooves 131c are formed at the housing part 131. Further, the first coupling holes 131a may have the holding portion 131a-1 protruding inward to hold the first fixing pins 111a so that the first fixing pins 111a can be further strongly fixed.

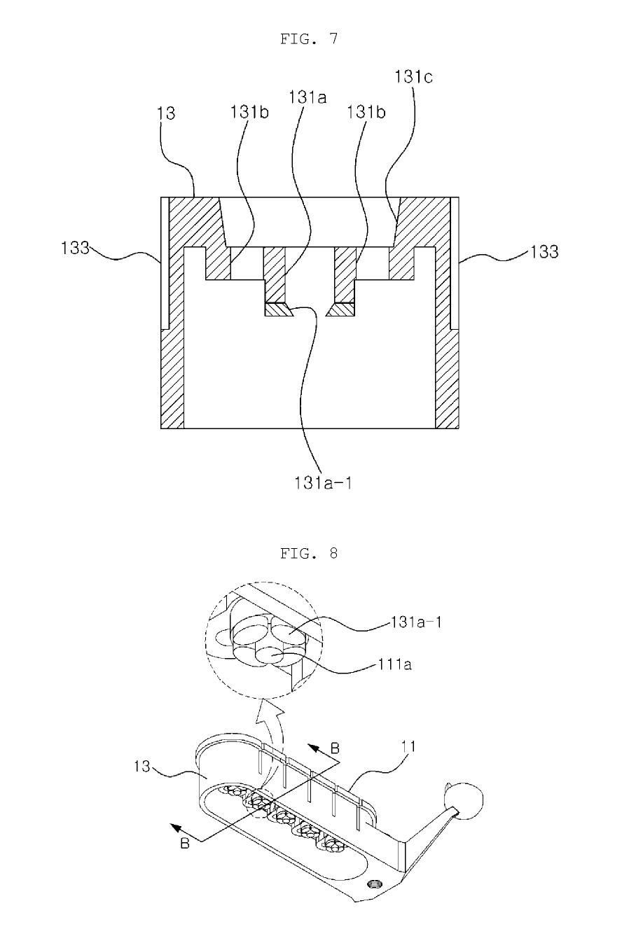

The holding portion 131a-1 is formed at the lower portion of the first coupling hole 131a in various shapes to increase a fixing force in accordance with the shape of the first fixing pin 111a. The holding portion 131a-1, as shown in FIG. 7, may be tapered to further protrude at the lower portion when the first fixing pin 111a is formed in a cylindrical rod shape. Accordingly, the holding portion 131a-1 can firmly fix the first fixing pin 111a by pressing the outer side of the first fixing pin. The holding portion 131a-1, as shown in FIG. 6, may be composed of two or more separate pins divided into several parts so that the first fixing pin 111a can be easily inserted.

The second coupling hole 131b, where the second fixing pin 111b is forcibly inserted and fixed, is formed at both sides of the first coupling hole 131a, may be formed in various shapes in accordance with the shape of the second coupling hole 131b, and may protrude downward at a distance corresponding to the length of the second fixing pin 111b. Accordingly, the inner side of the second coupling hole 131b and the outer side of the second fixing pin 111b are in close contact with each other, so the fixing force by the housing part 131 can be improved.

The rear projection groove 131c, where the rear projection 111c is forcibly inserted and fixed, may be formed in various shapes complementary to the shape of the rear projection 111c, and the first and second coupling holes 131a and 131b where the first and second fixing pins 111a and 111b are inserted are formed under the rear projection groove.

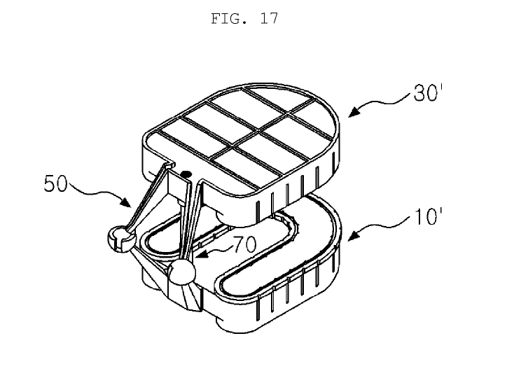

Referring to FIGS. 1, 2, and 12, the upper member 30 has a counter-tooth seat 31 where an impression of counter-teeth corresponding to the oral model 90 is seated and the counter-tooth seat 31 is formed in a curved plate shape higher at the front and rear and has a space for keeping an adhesive so that an impression can be easily seated and fixed. Since the upper member 30 has the counter-tooth seat 31 where counter-teeth are seated, it is possible to remove the process of manufacturing an oral model of counter-teeth using a plaster and then separating and attaching it to an articulator in the related art. An impression taking the shape of counter-teeth can be seated on the upper member 30 of the articulator according to the present invention, a counter-teeth oral model 90a can be manufactured thereon using a plaster, and the upper member is combined with the lower member 10 such that the shape, position, and occlusion state of a prosthesis can be checked, so the manufacturing process can be simplified. Further, at the upper member 30, as show in FIGS. 15 and 16, a support hole 73 or a guide surface 74 may be formed at the portion connected to the connecting mechanism 50 to face the pin hole 72 of the lower member 10, and the support hole 73 or the guide surface 74 allows the lower member 10 and the upper member 30 to replicate the motion of jawbones, in contact with the other end of the pin 71. The support hole 73 and the guide surface 74 will be described in detail below.

On the counter-tooth seat 31, which is the portion where an impression of counter-teeth is seated, an impression is fixed by an adhesive and the counter-tooth seat is formed in a curved plate shape with high front and rear sides for easy seating of an impression, as shown in FIG. 12. Further, the counter-tooth seat 31 has recessed adhesive spaces 311 to more stably fix an impression by keeping an adhesive such as a plaster and easily remove excessive adhesive. Further, the counter-tooth seat 31 may have tooth center marks 33 indicating the centers of teeth arranged on the counter-tooth seat 31.

The tooth center marks 33 have the same function as the tooth center marks 117 and 133 of the lower member 10, and as in the lower member 10, identification numbers may be written at the centers of teeth on the counter-tooth seat 31 or the tooth center marks may be embossed or engraved at both sides of the upper member 30. Accordingly, an impression can be attached to the counter-tooth seat 31, at the accurate position by the tooth center marks 33.

Referring to FIGS. 1, 2, 13, and 14, the connecting mechanism 50 connects the lower member 13 and the upper member 30 such that they can be rotated, and includes arms 51 formed at both sides of a side of each of the lower member 10 and the upper member 30, a ball 53 disposed at the end of one of the arms 51, and a pocket 52 formed at the end of the other arm with the top open. The ball on the arm 51 of the lower member 10 is inserted in the pocket 52 on the arm 51 of the upper member 30 and the ball 53 on the arm 51 of the upper member 30 is inserted in the pocket 52 on the arm 51 of the lower member 10. Accordingly, the connecting mechanism 50 has the configuration in which the balls 53 are inserted in the pockets 52, so free coupling and separating are possible, and not only up-down rotating, but left-right rotation are possible, so the upper member and the lower member 10 can replicate the motion of actual jawbones.

The arms 51, as shown in FIG. 2, has one end integrally formed with the lower member 10 or the upper member 30. That is, the arms 51 are divided into one integrally formed with the lower member 10 and one integrally formed with the upper member 30 and the two arms 51 connected to the lower member 10 and the upper member 30 have the same shape and function. Two arms 51 are formed at both sides and open outward, and the ball 53 is formed at the end of one of the arms 51 and the pocket 52 are formed at the end of the other arm 51. The arms 51 have a bending portion 511 that is bent at the portion close to the ball 53 and the pocket 52 such that the inclination decreases at the end so that the upper member 30 can be rotated 180° even if the depth of a slot 521 to be described below is not sufficient.

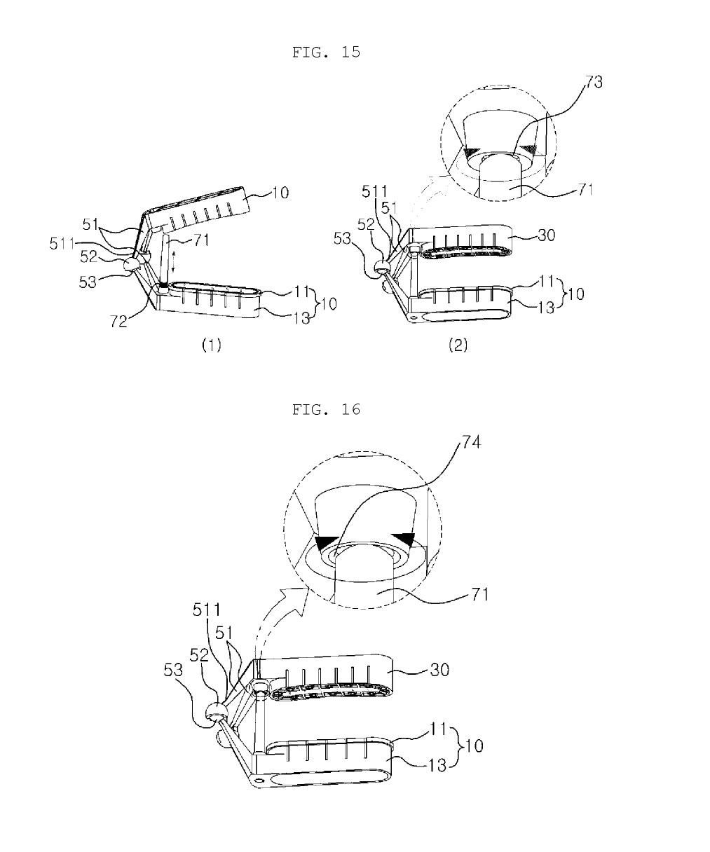

The pocket 52, as shown in FIG. 2, may be a hollow spherical shape such that the ball 53 can be inserted therein, but the top should be open so that the ball 53 can be inserted. Further, the pocket 52 may be cut at a position higher than the center to prevent the ball 53 from being separated from the pocket 52. This is because if the ball 53 is separated from the pocket 52 and the lower member 10 and the upper member 30 fall down to the left and right, the oral model 90 bonded to the lower member 10 and the upper member 30 by an adhesive such as a plaster may be separated or damaged. Further, the pocket 52, as shown in FIG. 14, may be inclined rearward such that the top of the pocket 52 supports the arm of the upper member 30 to ensure the height between the upper member 30 and the lower member 10, but a stopper 522 may be formed on the top of the front of the pocket so that the pocket 52 and the ball 33 are stably coupled, which will be described below. Further, the slot 521 is formed at the rear side of the pocket 52.

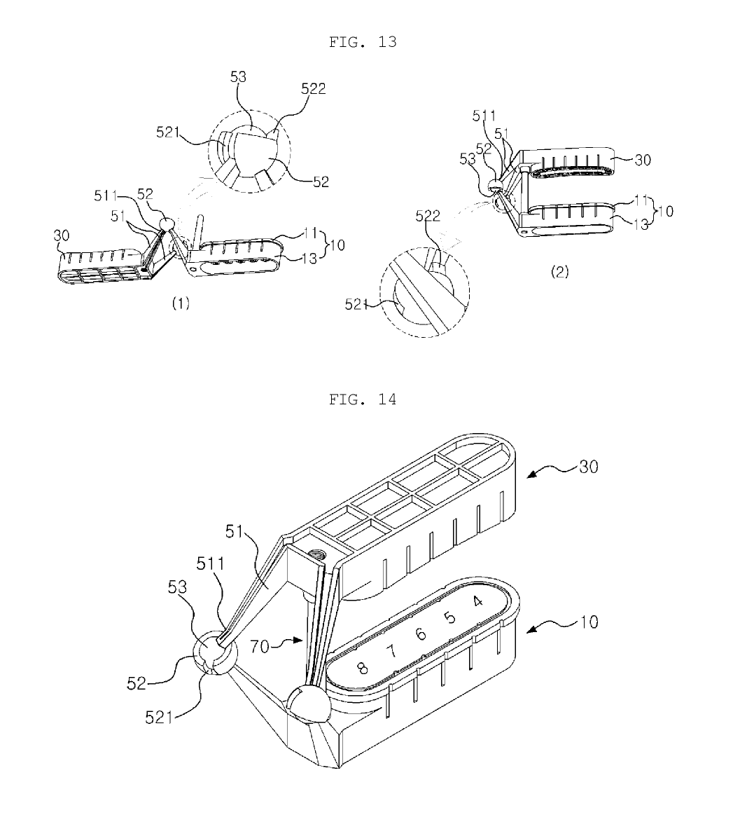

The slot 521 is formed downward at a predetermined depth at the rear side of the pocket 52 so that the ball 53 can be easily inserted into and separated from the pocket 52, so the arm 51 can be rotated into the slot 521 such that the lower member 10 and the upper member 30 can be rotated at 180°, as shown in FIG. 13. Accordingly, work can be performed simultaneously on both of the lower member 10 and the upper member 30 and it is possible to easily separate the oral model 90 for teeth to be replaced (manufactured) and the attachment plate 11 from the lower member 10, attach an impression to the upper member 30, and manufacture a model.

The stopper 522 protrudes upward at the top of the front of the pocket 52 to support the arm 51 integrally formed with the upper member 30. The stopper 522 can support the bottom of the arm 51 when the upper member 30 is moved down under a predetermined height so that a minimum height can be ensured between the lower member 10 and the upper member 30, so a work space is ensured and the oral models 90a and 90a attached to the lower member 10 and the upper member 30 are prevented from being damaged by hitting against each other.

The ball 53 is formed in a spherical shape to be inserted into the pocket 52 and connected to the arm 51 so that the lower and upper members can be rotated up/down and left/right. Accordingly, the lower member 10 and the upper member 30 can replicate the actual motion of jawbones.

Referring to FIG. 13, according to the operation of the lower member 10 and the upper member 30 by the connecting mechanism 50 composed of the arms 51, the pockets 52, and the balls 53, the lower member 10 and the upper member 30 can be rotated up to 180° by the slots 521 formed at the pockets 52, as described above, and work can be performed simultaneously on both members, as shown in FIG. 13 (1). Further, as shown in FIG. 13 (2), the stopper 522 ensures a minimum height between the lower member 10 and the upper member 30 by supporting the arm 51 connected to the upper member 30 so that the upper member 30 cannot be moved down any more.

Further, the articulator according to the present invention may include a support unit 70 that can ensure a height between the lower member 30 and the upper member 10 and the support unit 70 is described with reference to FIGS. 1, 2, and 15. The support unit 70 includes the pin 71 of which one end is fixed to the lower member 10 and the other end is supported on the upper member 30. Further, the support unit 70, as shown in FIG. 15, may include the pin hole 72 formed in the lower member 10 and having a thread on the inner side, in which the pin 71 has a thread on the outer side at an end to be thread-fastened to the pin hole 72 so that the height between the lower member 10 and the upper member 30 can be adjusted. Further, the support unit 70 may have the support hole 73 formed at the upper member 30 and supporting the other end of the pin 71, in which the other end of the pin 71 has a spherical shape having a diameter larger than the support hole 73 so that the upper member 30 can be rotated on the other end of the pin 71, and accordingly, the lower member 10 and the upper member 30 can naturally replicate the motion of jawbones. The minimum height of the lower member 10 and the upper member 30 can be ensured by the stopper 522 described above, when there is a need for a high position due to a loss of a back tooth or it is required to ensure a larger height between the lower member 10 and the upper member 30, the support unit 70 can be used.

The pin 71 may be formed in the shape of a cylindrical rod such that a thread is formed on one end and the other end is formed in a spherical shape having a diameter larger than the pin hole 72. Accordingly, one end of the pin 71, as shown in FIG. 15 (1), is inserted in and thread-fastened to the pin hole 72 of the lower member 10, so the height between the lower member 10 and the upper member 30 is adjusted in accordance with the degree of insertion of the pin 71 in the pin hole 72. Further, the other end of the pin 71, as shown in FIG. 15 (2), has a diameter lager than the support hole 73 formed at the opposite side, that is, at the upper member 30, so it is not fully, but partially inserted in the support hole 73. Accordingly, the support hole 73 can be rotated on the spherical other end of the pin 71 and the upper member 30 having the support hole 73 can also be rotated left and right, so the articulator can replicate the natural motion of jawbones. Further, one end of the pin 71 may be simply coupled to the lower member 10 without a thread.

The pin hole 72 is formed at the lower member 10 and has a thread on the inner side. As described above, one end of the pin 71 having a thread is inserted and fixed in the pin hole 72 and the height between the lower member 10 and the upper member 30 is adjusted in accordance with the degree of insertion of the pin 71. However, a groove may be formed in the pin hole 72 to fix the pin 71 or an adhesive may be used to couple the pin 71.

The support hole 73 is formed at the upper member 30 and has a diameter smaller than the other end of the pin 71 so that the pin 71 is not fully inserted therein. Accordingly, the support hole 73 can rotate on the other end of the pin 71, so the lower member 10 and the upper member 30 can replicate the natural motion of jawbones. Further, the support hole 73 may protrude as high as the upper member 30 so that the upper member 30 can be rotated without interference by the pin 71. A thread may be formed on the inner side of the support hole 73 so that the pin 71 is inserted and fixed in the support hole 73.

According to another embodiment of the support unit 70, as shown in FIG. 16, the support unit 70 may have a guide surface 74 for guiding the other end of the pin 71, in which the other end of the pin 71 may be formed in a spherical shape and the guide surface 74 may be curved to be complementary to the other end of the pin 71 so that the upper member 20 rotates with the guide surface 74 and the other end of the pin 71 in contact with each other and accordingly the upper member 30 and the lower member 10 replicate the natural motion of jawbones.

The guide surface 74 is recessed downward and curved so that the other end of the pin 71 can rotate in contact with it. The guide surface 74, similar to the support hole 73 of the previous embodiment, may protrude as high as the upper member 30 so that the upper member 30 can be rotated without interference by the pin 71.

It may be possible to switch the lower member 10 and the upper member 30 described above, that is, the lower member 10 may has the configuration of the upper member 30 and the upper member 30 may have the configuration of the lower member 10.

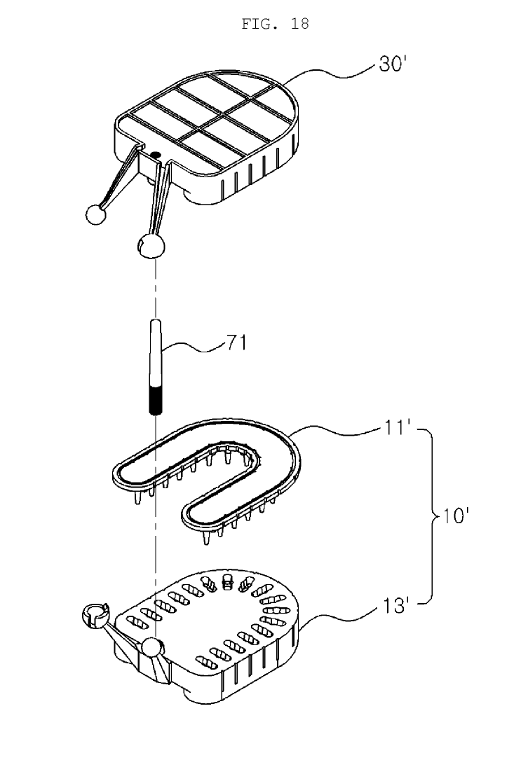

Referring to FIGS. 17 and 18, an articulator according to another embodiment of the present invention includes a lower member 10′ having an attachment plate 11′ where an oral model for whole teeth is attached, an upper member 30′ corresponding to the lower member 10′, and connecting mechanisms 50 rotatably connecting the lower member 10′ and the upper member 30′. Further, the articulator may include a height adjuster 70 that can adjust the height between the lower member 10′ and the upper member 30′. The articulator is the same as the articulator according to the previous embodiment of the present invention except that an oral model for whole teeth is attached to the attachment plate 11′, a body 13′ is combined with the attachment plate 11′, and an impression of teeth corresponding to the oral model for whole teeth is attached to the upper member 30′, so the detailed description is not provided.

Although various embodiments of the present invention by the applicant(s) were described above, the embodiments are just examples for achieving the spirit of the present invention and any modifications and changes should be construed as being included in the scope of the present invention as long as they can achieve the spirit of the present invention.

1. An articulator comprising:
a lower member where an oral model for teeth to be manufactured is seated;
an upper member where an impression of counter-teeth is seated; and
connecting mechanisms rotatably connecting the lower member and the upper member to each other,
wherein the lower member includes: an attachment plate having a model seat on a top where the oral model is fixed and a rear coupling part protruding downward to be detachably coupled to a body; and the body having a housing part for coupling the rear coupling part to the attachment plate by pressing the rear coupling part so that there is no need for using a plaster.

2. The articulator of claim 1, wherein the upper member has a counter-tooth seat where the impression of counter-teeth corresponding to the oral model is seated and the counter-tooth seat is formed in a curved plate shape higher at front and rear sides and has a space for keeping an adhesive so that the impression is easily seated and fixed.

3. The articulator of claim 1, wherein the rear coupling part has first fixing pins fitted downward through the body and the housing part has first coupling holes where the first fixing pins are fixed so that the attachment plate is easily separated.

4. The articulator of claim 3, wherein the first coupling holes have a holding portion protruding inward to hold the first fixing pins inserted through the first coupling holes.

5. The articulator of claim 4, wherein the holding portion is divided into a plurality of parts so that the first fixing pin is easily inserted and firmly fixed.

6. The articulator of claim 5, wherein the first fixing pin is formed in a cylindrical rod shape and the holding portion is tapered to further protrude at a lower portion.

7. The articulator of claim 3, wherein the rear coupling part has second fixing pins formed at both sides of the first fixing pins and inserted in the body and the housing part has second coupling holes where the second fixing pins are inserted to prevent rotation and easily set a position of the attachment plate combined with the body.

8. The articulator of claim 7, wherein the rear coupling part has rear projections that are inserted in the body and under which the first and second fixing pins are formed and the housing part has rear projection grooves where the rear projections are inserted and under which the first and second coupling holes are formed so that the attachment plate is more stably fixed to the body.

9. The articulator of claim 8, wherein the rear projections and the rear projection grooves are tapered such that cross-sections of lower portions become small.

10. The articulator of claim 1, wherein the attachment plate has cutting marks indicating portions between teeth on the model seat and positioned between adjacent first fixing pins so that the oral model and the attachment plate are accurately cut by the cutting marks.

11. The articulator of claim 10, wherein the cutting marks are formed at both sides of the model seat so that the attachment plate is accurately cut along a line connecting the cutting marks at both sides, even with the oral model in the model seat.

12. The articulator of claim 10, wherein the attachment plate has a round groove formed along an edge of the model seat to prevent overflow of an adhesive for fixing the oral model to the model seat.

13. The articulator of claim 10, wherein when the attachment plate is combined with the body, an outer side of the attachment plate protrudes further than an outer side of the body.

14. The articulator of claim 2, comprising tooth center marks indicating centers of teeth on the model seat and a counter-tooth seat.

15. The articulator of claim 14, wherein the tooth center marks are engraved or embossed at both sides of the attachment plate, the body, and the upper member.

16. The articulator of claim 14, wherein the tooth center marks are identification numbers written at centers of teeth on the model seat and the counter-tooth seat.

17. The articulator of claim 1, wherein the connecting mechanism includes: arms formed at both sides of an end of each of the lower member and the upper member; balls formed at an end of one of the arms; and a pocket formed at an end of the other arm and having an open top, wherein the ball formed at the arm of the lower member is inserted in the pocket formed at the arm of the upper member and the ball formed at the arm of the upper member is inserted in the pocket formed at the arm of the lower member.

18. The articulator of claim 17, wherein the pocket has a spherical shape with an open top and is cut at a position higher than a center of the sphere to prevent the ball from being separated from the pocket.

19. The articulator of claim 18, wherein a slot is formed at a rear side of the pocket so that the lower member and the upper member are rotated at 180°.

20. The articulator of claim 19, wherein the pocket has a stopper formed at the top of a front side to support the arm so that a minimum height is ensured between the upper member and the lower member.

21. The articulator of claim 19, comprising a support unit for ensuring a height between the upper member and the lower member and includes a pin having a first end coupled and fixed to the lower member and a second end supported on the upper member.

22. The articulator of claim 21, wherein the support unit includes a pin hole formed at the lower member and having a thread on an inner side and the first end of the pin has a thread on an outer side and is thread-fastened to the pin hole, so the height between the upper member and the lower member is adjusted.

23. The articulator of claim 21, wherein the support unit includes a support hole formed at the upper member and supporting the second end of the pin and the second end of the pin is formed in a spherical shape having a diameter lager than the support hole so that the upper member rotate on the second end of the pin, so the upper member and the lower member replicate a natural motion of jawbones.

24. The articulator of claim 21, wherein the support unit includes a guide surface formed at the upper member and guiding the second end of the pin, the second end of the pin is formed in a spherical shape, and the guide surface is curved to be complementary to the second end of the pin so that the upper member rotates with the guide surface and the second end of the pin in contact with each other, so the upper member and the lower member replicate a natural motion of jawbones.

25. The articulator of claim 17, wherein the upper member and the lower member are one-side parts where an oral model and an impression for only some of teeth are attached respectively, or an oral model and an impression for whole teeth are attached to the upper member and the lower member.
